(19) United States
(12) Patent Application Publication
(10) Pub. No.: US 2013/0009756 A1
(43) Pub. Date: Jan. 10, 2013

(54) VERIFICATION USING NEAR FIELD COMMUNICATIONS

(75) Inventor: Wenhui Lu, Tampere (FI)

(73) Assignee: Nokia Corporation, Espoo (FI)

(21) Appl. No.: 13/178,143

(22) Filed: Jul. 7, 2011

(51) Int. Cl. G06K 7/01

(52) U.S. Cl. 340/10.42

(57) ABSTRACT

In a system for effecting a monetary transaction, there is provided a mobile terminal and a verification tag configured to receive wirelessly using Near Field Communications (NFC) a verification request signal from the terminal and, in response thereto, to transmit a NFC verification reply signal. The terminal includes a verification module for detecting the remote verification tag within range thereof by means of receiving the NFC verification reply signal from said tag. There is also provided an identity module 140 configured to transmit user identification data stored in the terminal to a NFC remote reader conditional on the verification module detecting the NFC verification reply signal from the verification tag.

### FIELD

The present invention relates to an apparatus, method and system for verification using the presence of a separate in-range wireless device, particularly using near field communications (NFC).

### BACKGROUND

NFC refers generally to a set of technologies involving wireless radio frequency (r.f.) data exchange over short distances, typically a distance of 4 cm or less. In use, a user positions their NFC device within range of a NFC reader to effect an exchange of data between the user's device and the reader. Radio Frequency Identification (RFID) is a well-known, if basic, example of NFC in its general sense.

One area in which NFC is currently being deployed is the field of mobile payments. That is, a user can pay for a product or service by means of a NFC-enabled mobile terminal, for example a mobile telephone, which includes a NFC chip or smartcard. The chip or memory on the user terminal stores data corresponding to a pre-paid credit and/or information pertaining to a user's debit or credit card. In order to make a payment, the user positions their terminal in close proximity to a point-of-sale (PoS) NFC reader; when in-range, a transaction is effected by means of the NFC reader receiving the user's payment data.

A problem with mobile payments is the potential security risk. If the NFC terminal is lost or stolen, it may be used to make unauthorised payments; for example, in the case of credit card information, the risk is present until the user notifies their bank or credit card company of the loss and the card is blocked. In the case of pre-paid credit stored on the phone, it is harder to prevent fraudulent use because there is no third party verification system as with a credit card. One way of alleviating this risk in both situations is to require the input of a user password or PIN at the user terminal before a transaction is initiated, that is before the user payment data is transferred to the PoS reader. However, this requires a dedicated user-interface, the manual storage and input of the PIN or password, and generally detracts from the intended simplicity of making mobile payments. Passwords and PINs can also be overseen, stolen or guessed.

### SUMMARY

According to a first aspect of the invention there is provided apparatus comprising:

a verification module for detecting an external verification tag within range thereof by means of receiving a first signal from said tag; and

an identity module configured to transmit user identification data stored in the apparatus to an external reader conditional on the verification module detecting the first signal from the verification tag.

The identity module may be configured to transmit the user identification data responsive to a second signal received from an external reader device.

The verification module may be configured to transmit a third signal to the remote verification tag for causing said tag to transmit the first signal when within range. Here, the verification module may be configured to transmit the third signal at periodic intervals. The verification module may be configured to transmit the third signal in response to the identity module receiving the second signal from the remote reader device.

Therein the third signal may include data for uniquely identifying the verification module to the remote verification tag.

The first signal may include data for uniquely identifying the remote verification tag to the verification module, the verification module being configured to authenticate the identity of the verification tag by means of comparing the data in the first signal with a set of stored data associated with a valid tag, and the identity module being configured to transmit the user identification data to the reader conditional on a positive comparison by the verification module.

The identification data in each or both of the first and third signal(s) may be encrypted.

The apparatus may be a mobile telephone handset.

The user identification data stored by the apparatus may correspond to data identifiable by an external payment system for effecting an electronic payment transaction.

A second aspect of the invention provides a system comprising:

an apparatus as above, and

a local verification tag configured to respond to receiving wirelessly the third signal from the verification module of the apparatus by transmitting wirelessly the first signal back to the verification module.

The local verification tag may be a passive device configured so as to be energised by means of the third signal in order to transmit wirelessly the first signal back to the verification module.

The local verification tag may be a ring, bracelet or other wearable device.

The apparatus and the local verification tag may each comprise a near field communication transceiver for communication therebetween.

A third aspect of the invention provides a system for effecting a monetary transaction, the system comprising:

a verification tag configured to receive wirelessly using a near field communication verification request signal and, in response thereto, to transmit a near field communication verification reply signal; and

apparatus for transmitting to the tag the near field communication verification request, and comprising
a verification module for detecting the remote verification tag within range thereof by means of receiving the near field communication verification reply signal from said tag; and
an identity module configured to transmit user identification data stored in the apparatus to a near field communication remote reader conditional on the verification module detecting the near field communication verification reply signal from the verification tag.

A fourth aspect of the invention provides a method comprising:
in a processing apparatus:
   detecting an external verification tag within range thereof by means of receiving a first signal from said tag; and
   transmitting user identification data stored in the apparatus to an external reader conditional on detecting the first signal from the verification tag.

The method may comprise an identity module transmitting the user identification data responsive to a second signal received from an external reader device.

The method may comprise the verification module transmitting a third signal to the remote verification tag for causing said tag to transmit the first signal when within range.

The method may comprise the verification module transmitting the third signal at periodic intervals.

The method may comprise the verification module transmitting the third signal in response to the identity module receiving the second signal from the remote reader device.

A fifth aspect of the invention provided a computer program comprising instructions that when executed by computer apparatus control it to perform the method above.

A sixth aspect of the invention provides a non-transitory computer-readable storage medium having stored thereon computer-readable code, which, when executed by computing apparatus, causes the computing apparatus to perform a method comprising:

detecting an external verification tag within range thereof by means of receiving a first signal from said tag; and

transmitting user identification data stored in the apparatus to an external reader conditional on detecting the first signal from the verification tag.

A sixth aspect of the invention provides apparatus, the apparatus having at least one processor and at least one memory having computer-readable code stored thereon which when executed controls the at least one processor:

detecting an external verification tag within range thereof by means of receiving a first signal from said tag; and

transmitting user identification data stored in the apparatus to an external reader conditional on detecting the first signal from the verification tag.

### BRIEF DESCRIPTION

Embodiments of the present invention will now be described, by way of example only, with reference to the accompanying drawings, in which:

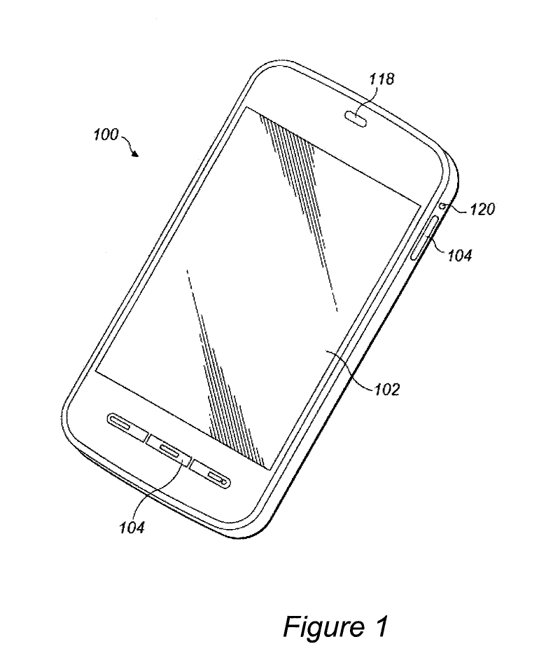

FIG. 1 is a perspective view of a mobile terminal embodying aspects of the invention;

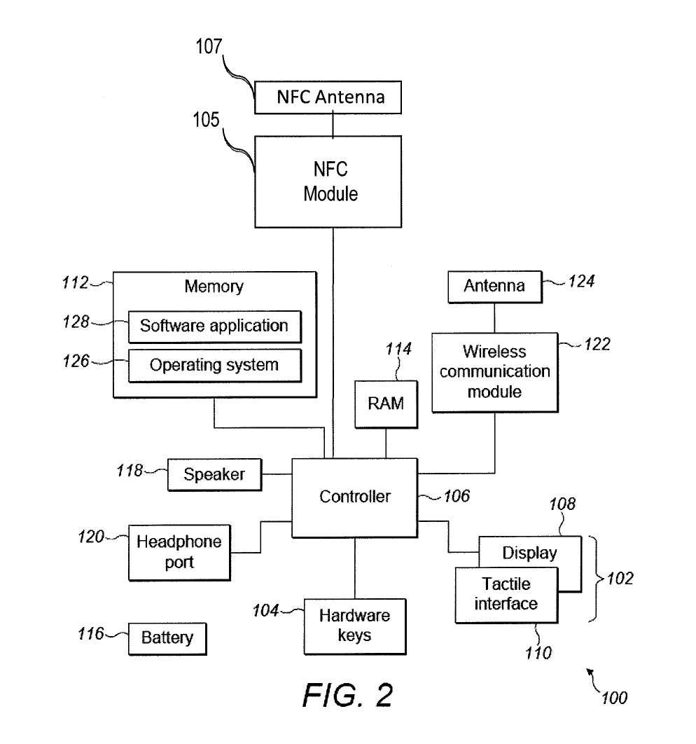

FIG. 2 is a schematic diagram illustrating components of the FIG. 1 mobile terminal and their interconnection;

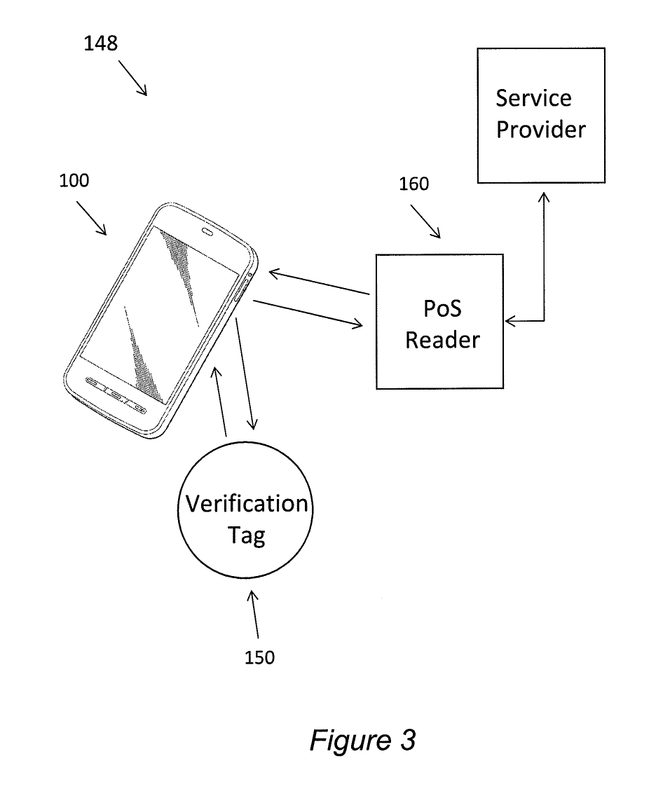

FIG. 3 is a schematic diagram of a payment system which includes the terminal shown in FIG. 1 as a component thereof;

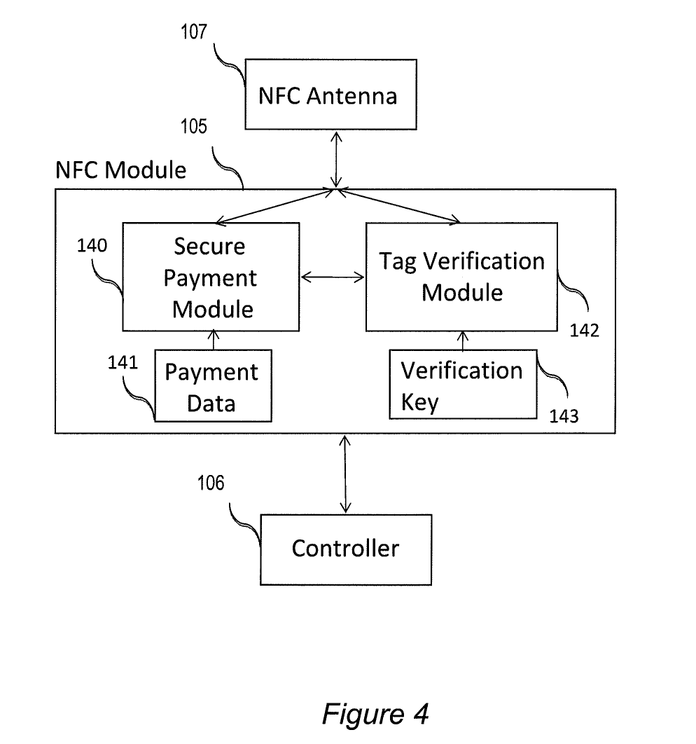

FIG. 4 is a schematic diagram illustrating components of a Near Field Communications (NFC) module which is provided in the terminal shown in FIG. 1;

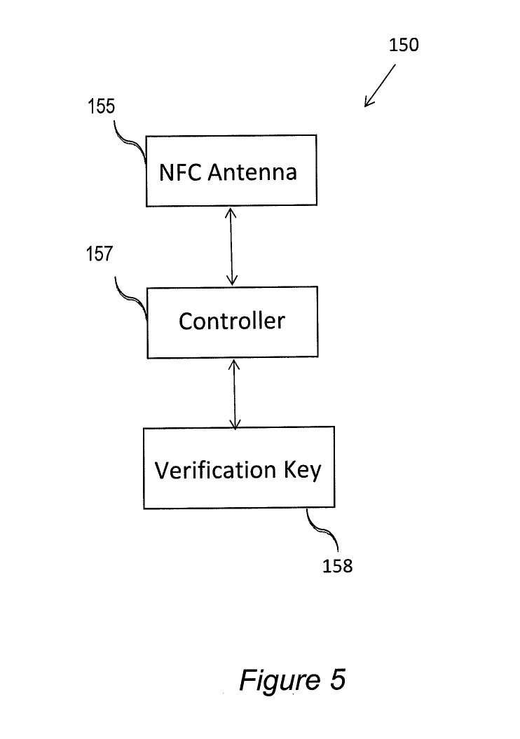

FIG. 5 is a schematic diagram illustrating components of a verification tag shown in FIG. 2; and

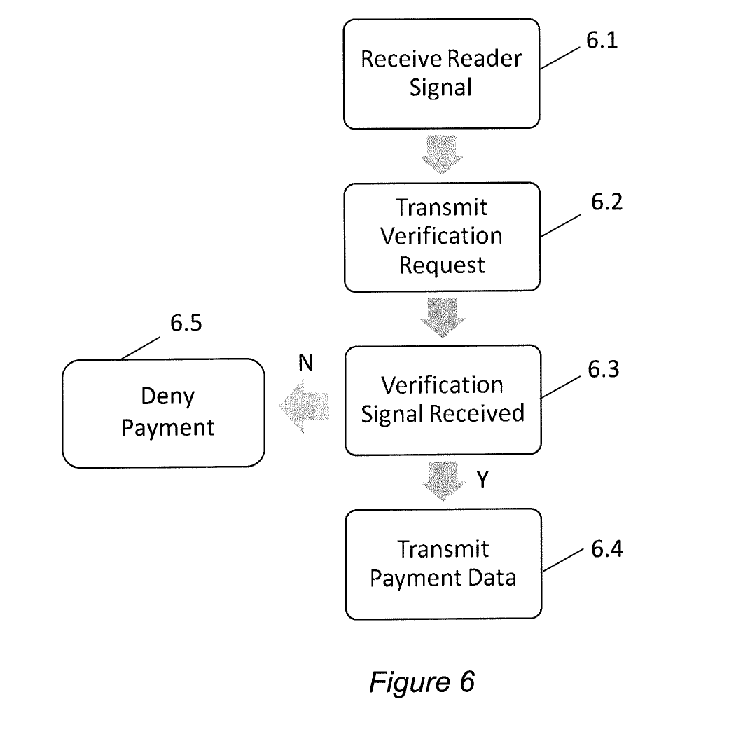

FIG. 6 is a flow diagram illustrating functional steps performed by the NFC module shown in FIG. 4.

### DETAILED DESCRIPTION

Referring firstly to FIG. 1, a terminal 100 is shown. The exterior of the terminal 100 has a touch sensitive display 102, hardware keys 104, a rear-facing camera 105, a speaker 118 and a headphone port 120.

FIG. 2 shows a schematic diagram of the components of terminal 100. The terminal 100 has a controller 106, a touch sensitive display 102 comprised of a display part 108 and a tactile interface part 110, the hardware keys 104, the camera 105, a memory 112, RAM 114, a speaker 118, the headphone port 120, a wireless communication module 122, an antenna 124 and a battery 116. The controller 106 is connected to each of the other components (except the battery 116) in order to control operation thereof.

The memory 112 may be a non-volatile memory such as read only memory (ROM) a hard disk drive (HDD) or a solid state drive (SSD). The memory 112 stores, amongst other things, an operating system 126 and may store software applications 128. The RAM 114 is used by the controller 106 for the temporary storage of data. The operating system 126 may contain code which, when executed by the controller 106 in conjunction with RAM 114, controls operation of each of the hardware components of the terminal.

The controller 106 may take any suitable form. For instance, it may be a microcontroller, plural microcontrollers, a processor, or plural processors.

Additionally, the terminal 100 has a Near Field Communications (NFC) module 105 and associated NFC antenna 107. The NFC module 105 is configured to effect monetary transactions by means of contactless interaction with one or more NFC readers associated with a point-of-sale (PoS). The NFC antenna 107 communicates with other, remote, NFC modules wirelessly at a frequency in the order of 13.56 GHz and at a range in the order of 4 cm or less. The operation of the NFC module 105 will be described in greater detail below.

The terminal 100 may be a mobile telephone or smartphone, a personal digital assistant (PDA), a portable media player (PMP), a portable computer or any other device capable of running software applications and providing audio outputs. In some embodiments, the terminal 100 may engage in cellular communications using the wireless communications module 122 and the antenna 124. The wireless communications module 122 may be configured to communicate via several protocols such as GSM, CDMA, UMTS, Bluetooth and IEEE 802.11 (Wi-Fi).

The display part 108 of the touch sensitive display 102 is for displaying images and text to users of the terminal and the tactile interface part 110 is for receiving touch inputs from users.

As well as storing the operating system 126 and software applications 128, the memory 112 may also store multimedia files such as music and video files. A wide variety of software applications 128 may be installed on the terminal including web browsers, radio and music players, games and utility applications. Some or all of the software applications stored on the terminal may provide audio outputs. The audio provided by the applications may be converted into sound by the speaker(s) 118 of the terminal or, if headphones or speakers have been connected to the headphone port 120, by the headphones or speakers connected to the headphone port 120.

In some embodiments the terminal 100 may also be associated with external software application not stored on the terminal. These may be applications stored on a remote server device and may run partly or exclusively on the remote server device. These applications can be termed cloud-hosted applications. The terminal 100 may be in communication with the remote server device in order to utilise the software application stored there. This may include receiving audio outputs provided by the external software application.

In some embodiments, the hardware keys 104 are dedicated volume control keys or switches. The hardware keys may for example comprise two adjacent keys, a single rocker switch or a rotary dial. In some embodiments, the hardware keys 104 are located on the side of the terminal 100.

The terminal 100 is configured for use as part of a contactless payment system 148, as represented in FIG. 3. The terminal 100, which includes the above-described NFC module 105 and antenna 107, is associated with a separate verification tag 150 which itself comprises NFC functionality to allow two-way data communications between the two devices. The purpose of the verification tag 150 is to provide a degree of security for the user when making a contactless payment. Particularly, as will be explained below, the NFC module 105 of the terminal 100 is configured only to effect payment or a payment request if the verification tag 150 is within detectable range. The detecable range typically is 4 cm (40 mm) or less.

In this way, a person attempting payment by means of the terminal 100 is required to have the verification tag 150 nearby, preferably on their person. For this reason, the preferred form of the verification tag 150 is as a wearable item such as a ring, watch, or key-fob.

A further part of the overall system 148 includes a PoS reader 160 which is associated with a vendor, for example a shop, transportation facility or vending machine. In this case, the PoS reader 160 is connected to a service provider 170 which processes payment requests received wirelessly from the terminal 100. The service provider may, for example, be a bank or credit card facility.

Referring to FIG. 4, the functional modules which comprise the NFC module 105 within the terminal 100 are shown. The NFC module 105 comprises a secure payment module (SPM) 140, payment data 141, a tag verification module (TVM) 142 and a verification key 143.

The SPM 140 is configured to detect payment requests received in a signal through the NFC antenna 107 from a PoS reader 160. To proceed with the payment process, the SPM 140, in response to receiving the payment request, is further configured to access the payment data, which is particular to the user, and transfers said payment data back to the reader 106 that made the payment request. However, as noted above, this is conditional on detecting the presence of the verification tag 150 within range of the NFC module 105. For this purpose the TVM 142 is configured to detect, by means of a verification signal received from the verification tag 150, the presence thereof. Particularly, the TVM 142 generates a verification request signal which is transmitted using the NFC antenna 107 to the verification tag 107, which sends the verification signal back to the TVM if it is within range.

The payment data 141 may be debit or credit card information. Alternatively, the payment data 141 may correspond to a pre-paid balance, thereby enabling confirmation of sufficient credit on the balance to make a payment.

The verification request signal may be transmitted periodically in response to a dedicated payment application being executed on the terminal 100. Alternatively, the verification request signal may be transmitted in response to the SPM 140 detecting a payment request signal from a PoS reader 160.

The TVM 142 is preferably ‘paired’ with the verification tag 150 so that the TVM 142 can distinguish between a valid verification tag 150 and a signal from a different source, e.g. another verification tag. For this purpose, the verification key 143 represents a ‘shared secret’ also present on the verification tag 150. If the shared secret is not detected in the verification signal sent back from the verification tag 150, then the TVM 142 will not detect the presence of a valid tag and the SPM 140 will prevent transfer of the payment data 141 to the PoS reader 160.

Referring to FIG. 5, the functional modules of the verification tag 150 are shown. The verification tag 150 comprises a NFC antenna 155, a controller 157 and a verification key 158 which, as noted above, represents a shared secret for inclusion in the verification signal it sends back to the terminal 100 in response to receiving a verification request signal therefrom.

Pairing can be performed when the user acquires a verification tag 150. Typically, the user will run a dedicated application on the terminal, which, following entry of a password or PIN, enables the tag verification module 142 in a ‘pairing’ mode. The user is then prompted to hold the tag 150 close to the terminal 100 so that the tag's verification key can be acquired and stored as the verification key 143 associated with the TVM 142.

Additional security can be provided between the TVM 142 and the verification tag 150, for example by encrypting one or both of the transmitted verification request signal and/or the received verification signal, using public or private key encryption.

Referring to FIG. 6, the functional steps performed by the NFC module 105 of the terminal 100 are indicated. In a first step 6.1, a signal is received by the SPM 140 from the PoS reader 160. In a second step 6.2, the TVM 142 transmits a verification request signal. In a third step 6.3, the TVM 142 detects whether a valid verification signal is received from the verification tag 150. If so, then in step 6.4, the SPM 140 transmits the payment data 141 back to the PoS reader 160. If not, then in step 605, payment is denied; in other words, no payment data 141 is transmitted to the PoS reader 160 and a denial message is output on a user interface of the terminal 100.

Using the above described apparatus and methods, the user of the terminal 100 can be verified, allowing payment to be made, on the basis of presence of the verification tag. This can avoid the need for PIN or password authentication and the like, thus simplifying the process for the user. Moreover, this can be achieved with high security since the verification tag is required to be present. The verification tag may be susceptible to being stolen along with the terminal 100, which would allow thieves to execute payments until the terminal 100 was blocked. However, the above described methods and apparatus are not susceptible to problems with PIN or password authentication in that guessing or overlooking is not possible. Also, unless a thief knew that a verification tag was required in order to process payments using the terminal 100, they might be unlikely to steal the verification tag along with the terminal 100, thus they would not be able to use the terminal for NFC payments. Configuring the verification tag as a wearable item provides security since a wearable tag is more easily hidden than a tag carried for instance in a bag or pocket.

Configuring the verification tag as a wearable item also makes it easier for a user to remember to take the verification tag with them when they leave their home or office.

It will be appreciated that the NFC module 105 can be implemented in hardware, software or a combination of both.

It will be appreciated that the above described embodiments are purely illustrative and are not limiting on the scope of the invention. Other variations and modifications will be apparent to persons skilled in the art upon reading the present application.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. (canceled)

2. Apparatus according to claim 23, wherein the at least one memory includes computer-readable code which, when executed, causes the at least one processor to transmit the user identification data responsive to a second signal received from an external reader device.

3. Apparatus according to claim 23, wherein the at least one memory includes computer-readable code which, when executed, causes the at least one processor to transmit a third signal to the remote verification tag for causing said tag to transmit the first signal when within range.

4. Apparatus according to claim 3, wherein the at least one memory includes computer-readable code which, when executed, causes the at least one processor to transmit the third signal at periodic intervals.

5. Apparatus according to claim 3, wherein the at least one memory includes computer-readable code which, when executed, causes the at least one processor to transmit the user identification data responsive to a second signal received from an external reader device and to transmit the third signal in response to the identity module receiving the second signal from the remote reader device.

6. Apparatus according to claim 23, wherein the third signal includes data for uniquely identifying the verification module to the remote verification tag.

7. Apparatus according to claim 23, wherein the first signal includes data for uniquely identifying the remote verification tag to the verification module, and wherein the at least one memory includes computer-readable code which, when executed, causes the at least one processor to authenticate the identity of the verification tag by means of comparing the data in the first signal with a set of stored data associated with a valid tag, and to transmit the user identification data to the reader conditional on a positive comparison by the verification module.

8. Apparatus according to claim 6, wherein the identification data in each or both of the first and third signal(s) is encrypted.

9. Apparatus according to claim 23, wherein the apparatus is a mobile telephone handset.

10. Apparatus according to claim 23, wherein the user identification data stored by the apparatus corresponds to data identifiable by an external payment system for effecting an electronic payment transaction.

11. A system comprising:
an apparatus having at least one processor and at least one memory having computer-readable code stored thereon which when executed controls the at least one processor:
to detect an external verification tag within range thereof by means of receiving a first signal from said tag; and
to transmit user identification data stored in the apparatus to an external reader conditional on detecting the first signal from the verification tag; and
a local verification tag configured to respond to receiving wirelessly the third signal from the verification module of the apparatus by transmitting wirelessly the first signal back to the verification module.

12. A system according to claim 11, wherein the local verification tag is a passive device configured so as to be energised by means of the third signal in order to transmit wirelessly the first signal back to the verification module.

13. A system according to claim 11, wherein the local verification tag is a ring, bracelet or other wearable device.

14. A system according to claim 11, wherein the apparatus and the local verification tag each comprise a near field communication transceiver for communication therebetween.

15. (canceled)

16. A method comprising:
in a processing apparatus:
detecting an external verification tag within range thereof by means of receiving a first signal from said tag; and
transmitting user identification data stored in the apparatus to an external reader conditional on detecting the first signal from the verification tag.

17. A method according to claim 16, comprising an identity module transmitting the user identification data responsive to a second signal received from an external reader device.

18. A method according to claim 16, comprising the verification module transmitting a third signal to the remote verification tag for causing said tag to transmit the first signal when within range.

19. A method according to claim 16, comprising the verification module transmitting the third signal at periodic intervals.

20. A method according to claim 16, comprising the verification module transmitting the third signal in response to the identity module receiving the second signal from the remote reader device.

21. (canceled)

22. A non-transitory computer-readable storage medium having stored thereon computer-readable code, which, when executed by computing apparatus, causes the computing apparatus to perform a method comprising:
detecting an external verification tag within range thereof by means of receiving a first signal from said tag; and
transmitting user identification data stored in the apparatus to an external reader conditional on detecting the first signal from the verification tag.

23. An apparatus having at least one processor and at least one memory having computer-readable code stored thereon which when executed controls the at least one processor:
to detect an external verification tag within range thereof by means of receiving a first signal from said tag; and
to transmit user identification data stored in the apparatus to an external reader conditional on detecting the first signal from the verification tag.
